(19) United States
(12) Patent Application Publication
(10) Pub. No.: US 2017/0090655 A1
(43) Pub. Date: Mar. 30, 2017

(54) Location-Independent Force Sensing Using Differential Strain Measurement

(71) Applicant: Apple Inc., Cupertino, CA (US)

(72) Inventors: Chang Zhang, Cupertino, CA (US); Dayu Qu, Cupertino, CA (US); Lei Ma, Cupertino, CA (US)

(21) Appl. No.: 15/264,565

(22) Filed: Sep. 13, 2016

Related U.S. Application Data
(60) Provisional application No. 62/234,596, filed on Sep. 29, 2015.

(51) Int. Cl. G06F 3/041

(52) U.S. Cl. CPC G06F 3/0416; G06F 3/0412; G06F 2203/04105; G06F 2203/04102

(57) ABSTRACT

A force sensor for detecting a force on a surface of a device. The force sensor may include a force-receiving layer and a substrate disposed below the force-receiving layer. A first force-sensitive component may be disposed on a surface of the substrate, and a second force-sensitive component may be disposed proximate to the first force-sensitive component. In some embodiments, sensor circuitry may be operatively coupled to the first and second force-sensitive components, and configured to compare a relative electrical response between the first force-sensitive component and the second force-sensitive component to compute a force estimate. The force estimate may compensate for a variation in response based on the location of the components relative to a location of the force.

### CROSS-REFERENCE TO RELATED APPLICATION

This application claims the benefit under 35 U.S.C. §119(e) of U.S. Provisional Patent Application No. 62/234,596, filed on Sep. 29, 2015, and entitled “Location-Independent Force Sensing Using Differential Strain Measurement,” the contents of which are incorporated by reference as if fully disclosed herein.

### FIELD

The disclosure relates generally to force sensing and, more specifically, to a location independent force sensor having two or more force-sensitive components disposed on a flexible substrate.

### BACKGROUND

Many electronic devices include some type of user input device, including, for example, buttons, slides, scroll wheels, and similar devices or user-input elements. Some devices may include a touch sensor that is integrated or incorporated with a display screen. The touch sensor may allow a user to interact directly with user-interface elements that are presented on the display screen. However, some traditional touch sensors may only provide a location of a touch on the device. Other than location of the touch, many traditional touch sensors produce an output that is binary in nature. That is, the touch is present or it is not.

In some cases, it may be advantageous to detect and measure the force of a touch that is applied to a surface to provide non-binary touch input. However, there may be several challenges associated with implementing a force sensor in an electronic device. For example, the location of the force sensor relative to a location of the force applied to the surface may introduce variation in the response of the force sensor, which may lead to unreliable force measurements. Additionally, temperature fluctuations in the device or environment may introduce an unacceptable amount of variability in the force measurements.

### SUMMARY

Embodiments providing a force sensor for detecting a force on a surface of a device are described herein. Various embodiments described herein include a force-receiving layer and a substrate disposed below the force-receiving layer. A first force-sensitive component may be disposed on a surface of the substrate, and a second force-sensitive component may be disposed proximate to the first force-sensitive component. In some embodiments, sensor circuitry may be operatively coupled to the first and second force-sensitive components, and configured to compare a relative electrical response between the first force-sensitive component and the second force-sensitive component to compute a force estimate. The force estimate may compensate for a variation in response based on the location of the components relative to a location of the force.

In some embodiments, the substrate may be configured to deflect in response to a force of a touch on the force-receiving layer. The first force-sensitive component may experience a first amount of tension and the second force-sensitive component may experience a second amount of tension in response to the force of the touch, and the first and second amounts of tension may vary based on the location of the force.

In some embodiments, the first and second force-sensitive components may be made of a piezoelectric material. In some embodiments, the first force-sensitive component may have a geometry which is distinct from the second force-sensitive component. In some embodiments, the first force-sensitive component may be disposed on a first side of the substrate, and the second force-sensitive component may be disposed on a second side of the substrate that is opposite to the first side.

In various embodiments, an electronic device may have a force sensor that includes a display, and a cover disposed above the display and forming a portion of an outer surface of the device. A first force-sensing component may be disposed below the cover and formed from a strain-sensitive material, and a second force-sensing component may be disposed adjacent the first force-sensing component and also formed from a strain-sensitive material. A sensor circuit may be operatively coupled to the first and second force-sensing components, and configured to measure a relative difference between an electrical response of the first and second force-sensing components in response to a force of a touch on the cover, and compute a force estimate using the relative difference.

In some embodiments, the first and second force-sensing components are disposed on an underside of the cover. In some embodiments, a polarizer may be disposed below the display and the first and second force-sensing components may be disposed on a surface of the polarizer. In some embodiments, a transparent substrate may be disposed below the cover, and the first and second force-sensing components may be disposed on a surface of the substrate. In some cases, the first force-sensing component may be disposed on a first surface of the substrate, and the second force-sensing component may be disposed on a second surface of the substrate that is opposite to the first surface.

In some embodiments, the first and second force-sensing components may be disposed relative to the display. In some embodiments, the device may include one or more layers forming a display stack of the electronic device, and the first and second force-sensing components may be disposed relative to the one or more layers of the display stack. In some cases, the first and second force-sensing components may be configured to deform with the display stack in response to the force of the touch. In some cases, the deformation of the first and second force-sensing components may generate an electrical response from the first and second force-sensing components, the electrical response may correspond to an amount of deformation of each force-sensing component. In some cases, the electrical response of the first force-sensing component may differ from the electrical response of the second force-sensing component, and the force estimate may compensate for the difference in the responses.

In various embodiments, a method for estimating an applied force to a surface of a device may be provided, and include: detecting a touch on the surface; measuring an electrical response of a first force-sensitive structure positioned relative to the surface and a second force-sensitive structure positioned proximate to the first force-sensitive structure in response to a force of the touch; determining a relative difference between the electrical response of the first force-sensitive structure and the electrical response of the second force-sensitive structure; and computing a force estimate based on the relative difference. In some embodiments, the method may further include compensating for temperature effects on the force estimate using the relative difference.

### BRIEF DESCRIPTION OF THE DRAWINGS

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 depicts an example electronic device.

FIG. 2 depicts a top view of an example force-sensitive structure including a grid of force-sensitive components.

FIG. 3A depicts a side view of a portion of an example force-sensitive structure of a device taken along section A-A of FIG. 1.

FIG. 3B depicts a side view of a portion of the example force-sensitive structure of FIG. 3A, that has been deformed in an exemplary manner in response to an applied force.

FIGS. 4A-4C depict side views of alternate example force-sensitive structures.

FIG. 5A depicts a side view of an alternate example force-sensitive structure.

FIG. 5B depicts a side view of the example force-sensitive structure of FIG. 5A, that has been deformed in an exemplary manner in response to an applied force.

FIG. 5C depicts a side view of the example force-sensitive structure of FIG. 5A, that has been deformed in another exemplary manner in response to an applied force.

FIG. 6A illustrates an example display stack of a device having force-sensitive structures disposed beneath a cover layer of the display stack.

FIG. 6B illustrates another example display stack of a device having force-sensitive structures disposed beneath a rear polarizer of the display stack.

FIG. 6C illustrates yet another example display stack having force-sensitive structures disposed beneath a support structure of the display stack.

FIG. 7 is a flow chart illustrating one example method for obtaining a force estimate which compensates for a variation in response based on a location of force-sensitive structures relative to a location of the applied force.

### DETAILED DESCRIPTION

Embodiments described herein may relate to or take the form of a force sensor that is incorporated with components of an electronic device to enable a force-sensitive surface of the device. Certain embodiments described herein also relate to force-sensitive structures including one or more force-sensitive components for detecting a magnitude of a force applied to a device. Some embodiments are directed to a force sensor that can estimate the magnitude of force applied by compensating for variations in responses of force-sensitive components based on their location relative to a location of a force applied to the device. Certain embodiments may also be directed to a force sensor that can compensate for effects of temperature on the strain responses, and may be optically transparent for integration with a display or transparent medium of an electronic device. In one example, a force-sensitive component is integrated with, or adjacent to, a display element of an electronic device. The electronic device may be, for example, a mobile phone, a tablet computing device, a computer display, a notebook computing device, a desktop computing device, a computing input device (such as a touch pad, track pad, keyboard, or mouse), a wearable device, a health monitor device, a sports accessory device, and so on.

Generally and broadly, a force exerted by a user's touch, or by an impact of any object, may be sensed on a display, enclosure, cover, or other surface associated with an electronic device using a force sensor adapted to determine a magnitude of force of the touch event. The determined magnitude of force may be used as an input signal, input data, or other input information to the electronic device. In one example, a high force input event may be interpreted differently from a low force input event. For example, a smart phone may unlock a display screen with a high force input event and may pause audio output for a low force input event. The device's responses or outputs may thus differ in response to the two inputs, even though they occur at the same point and may use the same input device. In further examples, a change in force may be interpreted as an additional type of input event. For example, a user may hold a wearable device force sensor proximate to an artery in order to evaluate blood pressure or heart rate. One may appreciate that a force sensor may be used for collecting a variety of user inputs.

In many examples, a force sensor may be incorporated into a touch-sensitive electronic device and located proximate to a display of the device, or incorporated into a display stack. Accordingly, in some embodiments, the force sensor may be constructed of optically transparent materials. For example, an optically transparent force sensor may include at least a force-receiving layer, a substrate including an optically transparent material, and a first and second force-sensitive component associated with the substrate. In many examples, the substrate may be disposed below the force-receiving layer such that upon application of force to the force-receiving layer, the substrate may experience compressive and tensile forces. In this manner, the force-sensitive components may experience deflection, tension, compression, or another mechanical deformation.

A force-sensitive component may be formed from a compliant material that exhibits at least one measurable electrical response that varies with a deformation, deflection, or shearing of the component. The force-sensitive component may be formed from a piezoelectric, piezoresistive, or other strain-sensitive material that is attached to or formed on a substrate and electrically or operatively coupled to sensor circuitry for measuring a change in the electrical response of the material. Example strain-sensitive materials include polyvinylidene fluoride (PVDF), poly-L-lactic acid piezoelectric (PLLA), polyethyleneioxythiophene (PEDOT), piezoelectric or piezoresistive polymeric materials, other strain-sensitive materials, and the like.

Transparent strain-sensing materials and/or substrate materials may be used in sensors that are integrated or incorporated with a display or other visual element of a device. If transparency is not required, then other component materials may be used. Non-transparent applications may include force-sensing on track pads, in input devices that lack a transparent surface, and/or behind display elements. In general, transparent and non-transparent force-sensitive components may be referred to herein as “force-sensitive components”, “force-sensing components”, or simply “components.”

Force-sensitive components may be formed by coating a substrate with a conductive material, attaching a conductive material, or otherwise depositing such a material on the substrate. In some embodiments, the force-sensitive components may be formed relative to a surface of a substrate. In one example, a plurality of force-sensitive components may be formed on a surface of a substrate, and the force-sensitive components may be positioned adjacent one another with respect to their position on the substrate. In some implementations, the substrate may deflect or deform in response to a force of a user touch. The deflection of the substrate may cause the surface of the substrate to expand or compress under tension, which may cause the force-sensitive components to also expand, compress, stretch, or otherwise geometrically change as a result of the deflection.

In some cases, the force-sensitive components may be placed under tension in response to a downward deflection. Once under tension, the force-sensitive components may exhibit a change in at least one electrical property, for example, voltage. The voltage of the force-sensitive components may increase or decrease with an increase in tension experienced by the components. One may appreciate that two or more adjacent components may experience different amounts of tension, and thus different changes in voltage due to their position on the substrate relative to the location of the force. Potential substrate materials include, for example, glass or transparent polymers like polyethylene terephthalate (PET) or cyclo-olefin polymer (COP).

In some embodiments, the force-sensitive components may be formed from a piezoelectric material. In some implementations, when the piezoelectric material is strained, the voltage of the component changes as a function of the strain. The change in voltage can be measured using sensing circuitry that is configured to measure small changes in the voltage of the force-sensitive component. In some cases, the sensing circuitry may be configured to measure the differential change in voltage between two or more adjacent force-sensitive components which experience different voltage changes based on their position relative to the force. In some cases, the differential strain may account for variations in the responses of the components (e.g., variations in voltage changes or strain) due to the components being positioned at different locations relative to the location of the force, and thus experiencing differing amounts of tension. In this way, a piezoelectric component can be used as a force sensor configured to estimate the application of force independent of the location of the applied force.

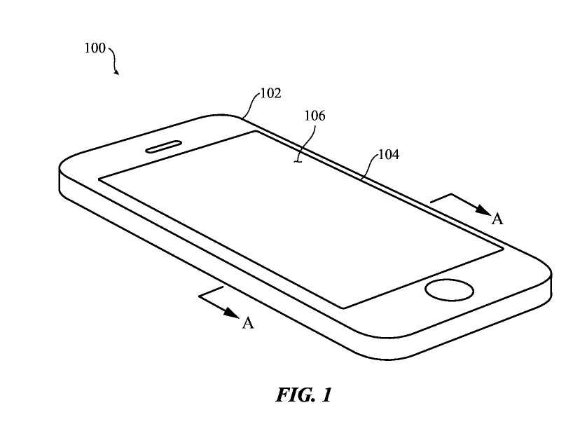

The foregoing and other embodiments are discussed below with reference to FIGS. 1-7. However, those skilled in the art will readily appreciate that the detailed description given herein with respect to these Figures is for explanatory purposes only and should not be construed as limiting.

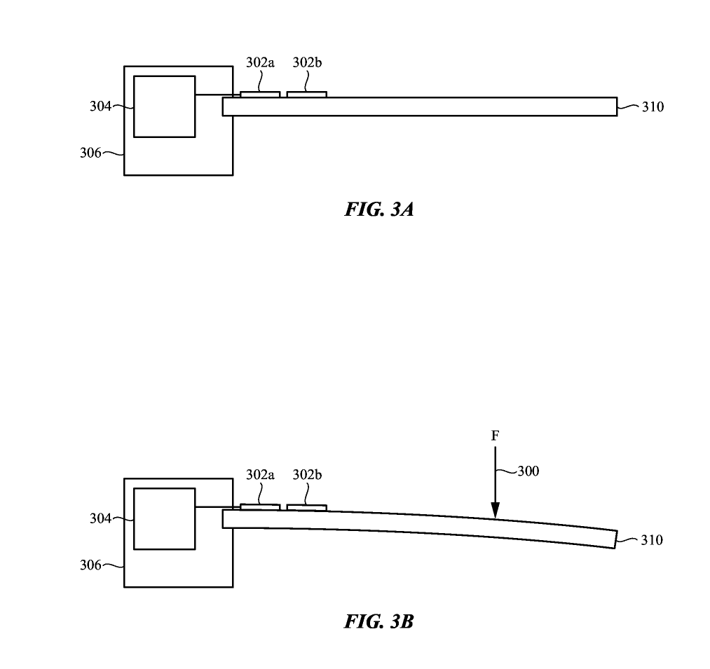

FIG. 1 depicts an example electronic device 100. The electronic device 100 may include a display 104 disposed or positioned within an enclosure 102. The display 104 may include a stack of multiple elements including, for example, a display element, a touch sensor layer, a force sensor layer, and other elements. The display 104 may include a liquid-crystal display (LCD) element, organic light emitting diode (OLED) element, electroluminescent display (ELD), and the like. The display 104 may also include other layers for improving the structural or optical performance of the display, including, for example, glass sheets, polymer sheets, polarizer sheets, color masks, and the like. The display 104 may also be integrated or incorporated with a cover glass 106, which forms part of the exterior surface of the device 100. Example display stacks depicting some example layer elements are described in more detail below with respect to FIGS. 3-5.

In some embodiments, a touch sensor and/or a force sensor are integrated or incorporated with the display 104. In some embodiments, the touch and/or force sensor enable a touch-sensitive surface on the device 100. In the present example, a touch and/or force sensor are used to form a touch-sensitive and/or force-sensitive surface that is at least a portion of the exterior surface of the cover 106. The touch sensor may include, for example, a capacitive touch sensor, a resistive touch sensor, or other device that is configured to detect the occurrence and/or location of a touch on the cover glass 106. The force sensor may include a strain-based force sensor similar to the force sensors described herein.

In some embodiments, each of the layers of the display 104 may be adhered together with an optically transparent adhesive. In other embodiments, each of the layers of the display 104 may be attached or deposited onto separate substrates that may be laminated or bonded to each other. The display 104 may also include other layers for improving the structural or optical performance of the display, including, for example, glass sheets, polarizer sheets, color masks, and the like.

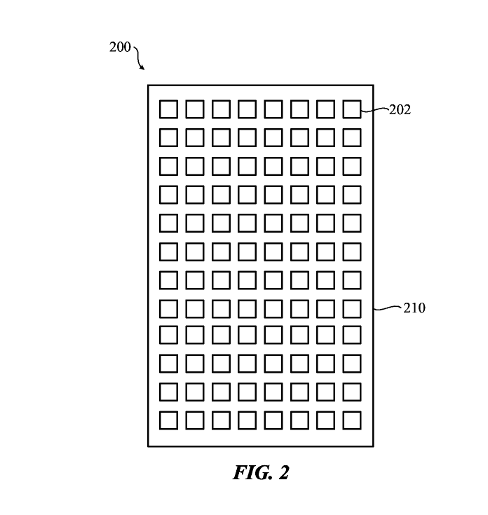

FIG. 2A depicts a top view of an example force-sensitive structure 200 including a grid of force-sensitive components. As discussed herein, the force sensitive components may be optically transparent for integration with a display or transparent medium of an electronic device, such as the example described above with respect to FIG. 1. As shown in FIG. 2A, the force-sensitive structure 200 includes a substrate 210 having disposed upon it a plurality of individual force-sensitive components 202. In this example, the substrate 210 may be an optically transparent material, such as polyethylene terephthalate (PET), glass, sapphire, diamond, and the like. The force-sensing components 202 may be made from conductive polymer materials including, for example, polyvinylidene fluoride (PVDF), poly-L-lactic acid piezoelectric (PLLA), polyethyleneioxythiophene (PEDOT), other piezoelectric or piezoresistive polymeric materials, other strain-sensitive materials, and the like. In certain embodiments, the force-sensing components 202 may be selected at least in part on temperature characteristics. For example, in embodiments employing a force-sensing component made from a PVDF material, temperature effects on the PVDF may be accounted for as described in more detail below.

As shown in FIG. 2A, a force-sensitive component 202 may be operationally coupled to an adjacent force-sensitive component, as further discussed below. In many examples, each individual force-sensing component 202 may have a shape and/or pattern that depends on the location of the force-sensing component 202 within the array. For example, in some embodiments, the force-sensing component 202 may be formed as a pattern of traces (not shown). Additionally, the force-sensing component 202 may include electrodes (not shown) for connecting to a sensing circuitry. In other examples, the force-sensing component 202 may be electrically connected to sense circuitry without the use of electrodes. For example, the force-sensing component 202 may be connected to sensing circuitry using conductive traces that are formed as part of the component layer.

In some embodiments, each force-sensing component 202 may be comprised of two strain sensors which are operationally connected to one another to output an electrical signal corresponding to the differential of the two strain sensors. In this manner, the strain sensors may cooperate to sense a force and provide a signal output based on the differential strain between the sensors. In some embodiments, adjacent force-sensing components 202 may be operationally connected to one another to output an electrical signal corresponding to the differential of the force-sensing components 202.

FIG. 3A depicts an example force-sensitive structure of a device, taken along section A-A of FIG. 1. As depicted in FIG. 3A, a substrate 310 may be disposed below a force-receiving layer of the device (not shown for ease of viewing) configured to receive a force directly from a user and/or receive a force via another layer or component of a display stack that is disposed relative to a surface of the force-receiving layer, and transfer or translate that force to the substrate 310 for force sensing. As shown in FIG. 3A, the substrate 310 may have at least two individual force-sensitive components 302a and 302b positioned thereon. The substrate may be supported on at least one side by a support structure 306 such that when a force is received by the substrate 310 (via, for example, a force-receiving layer of the device), the substrate may bend or deflect in response to that force. In this manner, the substrate 310 may function as a cantilever beam supported on one side by support structure 306.

In some embodiments, the substrate 310 may be made from an optically transparent material, such as polyethylene terephthalate (PET). The force-sensitive components 302 may be made from a piezoelectric or other strain-sensitive material, one example of which is PVDF. In some cases, the force-sensitive components 302 may be connected to sense circuitry 304 that is configured to detect changes in an electrical property of each of the force-sensitive components 302. In some cases, the sense circuitry 304 may be configured to detect changes in the voltage output of the force-sensitive components 302, which can be used to estimate a force that is applied to the device. In another example, sensing circuitry 304 may be configured to measure a change in resistance of the force-sensitive components 302, which can likewise be used to estimate an applied force.

In some embodiments, the sensing circuitry 304 may be adapted to determine a relative measurement between the electrical response of the two force-sensitive components 302a and 302b, as further described below with respect to FIG. 3B. In some cases, the electrical response of a force-sensitive component 302 may vary with each component's distance from an applied force.

As shown in FIG. 3B, an applied force 300 may cause the substrate 310 to at least partially deflect. Since the force-sensitive components 302 are affixed to the substrate 310, the force-sensitive components 302 may at least partially deflect as well. As a result of the force-sensitive components 302 being positioned at different distances from the location of the applied force 300, the force-sensitive components 302 may experience different degrees of deflection based on their location with respect to the force 300. That is, the deflection of the force-sensing components 302 may vary with the distance from the location of the force 300 of each respective force-sensitive component 302, and thus the electrical responses of those components may also vary in response to the same amount of force 300 applied. As an example, component 302b will experience a greater deflection than 302a since it is closer to the force 300.

In some embodiments, an electrical response due to the force 300 may be measured for each component 302, and a differential output may compare a relative response of the two adjacent components (e.g. 302a compared with 302b). In this manner, error present as a result of the components 302 experiencing different electrical responses due to their location relative to the location of the force 300 may be substantially reduced or eliminated. In addition, error present as a result of temperature changes may likewise be substantially reduced or eliminated without requiring dedicated error correction circuitry or specialized processing software. When the signals from the two components 302 are compared, the strain may appear as a differential strain. In some embodiments, the differential of the components 302 may be used to calculate a corresponding differential strain. In some cases, the differential output may be used to compute a force estimate that cancels the effects on strain due to, for example, the differences in the electrical responses of the two components 302 based on their respective distance from the force 300.

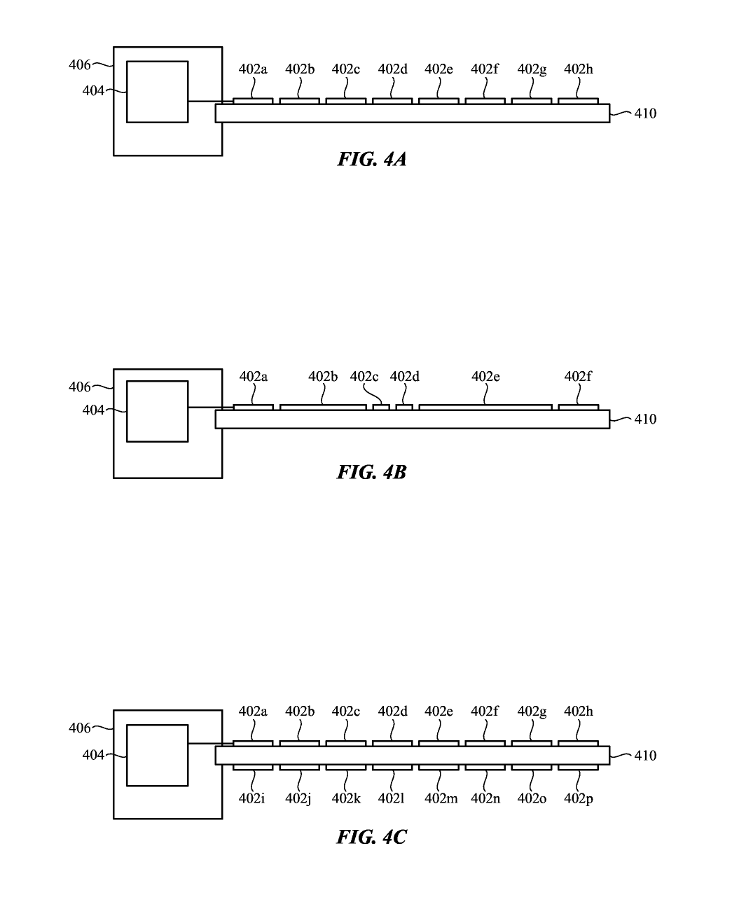

FIG. 4A depicts a side view of a portion of an additional example embodiment of a force-sensitive structure of a device. As depicted, a single strain sensing layer may include a substrate 410 having a plurality of strain sensors or force-sensing components 402 positioned thereon. In some embodiments, the substrate 410 may be supported on at least one side by a support structure 406. The strain sensing layer may be disposed below a force-receiving layer (not shown) that corresponds to a cover of a device or which is itself disposed below a cover of a device. The force-sensing components 402 may be positioned on a top surface of the substrate, such that the force-sensitive components 402 are oriented facing a bottom surface of a force-receiving layer. In some embodiments, the force-sensitive components may be positioned around a perimeter or edge portion of the substrate rather than across the surface of the substrate. The force-sensitive components 402 may be connected to sense circuitry 404 which may be adapted to measure a change in an electrical property of the force-sensitive components 402, in accordance with the previous discussion.

For embodiments having this configuration, variations in responses of the force-sensitive components 402 based on their locations relative to the location of a force may be compensated by determining the relative difference between two or more adjacent components 402. For example, when a user applies a force, a response (e.g., strain) may be measured at each of the force-sensitive components 402. As explained above, the measured strain may include unwanted variation between components 402 that are positioned at different distances from the applied force. Thus, by measuring the relative difference between the responses of two or more adjacent components, a force may be estimated independent of the location in which it is applied.

FIG. 4B depicts a side view of a portion of another example embodiment of a force-sensitive structure of a device. As with FIG. 3A, a plurality of force-sensitive components 402 may be disposed on a substrate which may receive force from a force-receiving layer (not shown). In some cases, the force-sensing components 402 may exhibit different strain and/or thermal properties at different locations about the substrate 410. For example, force-sensing component 402a may have a different geometry than force-sensing component 402b. The difference in geometry may be selected for any number of reasons. As an example, a larger strain sensor geometry may be necessary for portions of the substrate 410 which are expected to experience greater deformation than other portions of the substrate.

In one example, different geometries for different strain sensors may be selected based upon what electronic components may be disposed above, below, or otherwise adjacent or near the force-sensitive structure within an electronic device. In other cases, different geometries may be present for different expected force input areas. For example, certain embodiments may include a force-sensing area that is designed to be more sensitive than a second force-sensing area. Accordingly, the geometry of strain sensors included within these two areas may differ. In this manner, different regions of a substrate 410 may include different strain sensors 402. Strain sensors may differ in geometry, orientation, material, or other properties.

FIG. 4C depicts a side view of a portion of yet another example embodiment of a force-sensitive structure of a device. As depicted, a single strain layer may include a substrate 410 having a plurality of force-sensing components 402 positioned on opposing sides of the substrate 410. In particular, along a top surface of the substrate 410 may be a first plurality of force-sensing components 402a-h, similar to the embodiment shown in FIG. 4A. Positioned along a bottom surface of the substrate 410 may be a second plurality of force-sensitive components 402i-p. For embodiments having this configuration or related double-sided configurations, any dependency on the location of an applied force may be compensated for by measuring a difference between at least one of the first plurality of force-sensing components 402a-h against at least one of the second plurality of force-sensing components 402i-p. In this manner, a strain resultant from a user force input in any location may be measured.

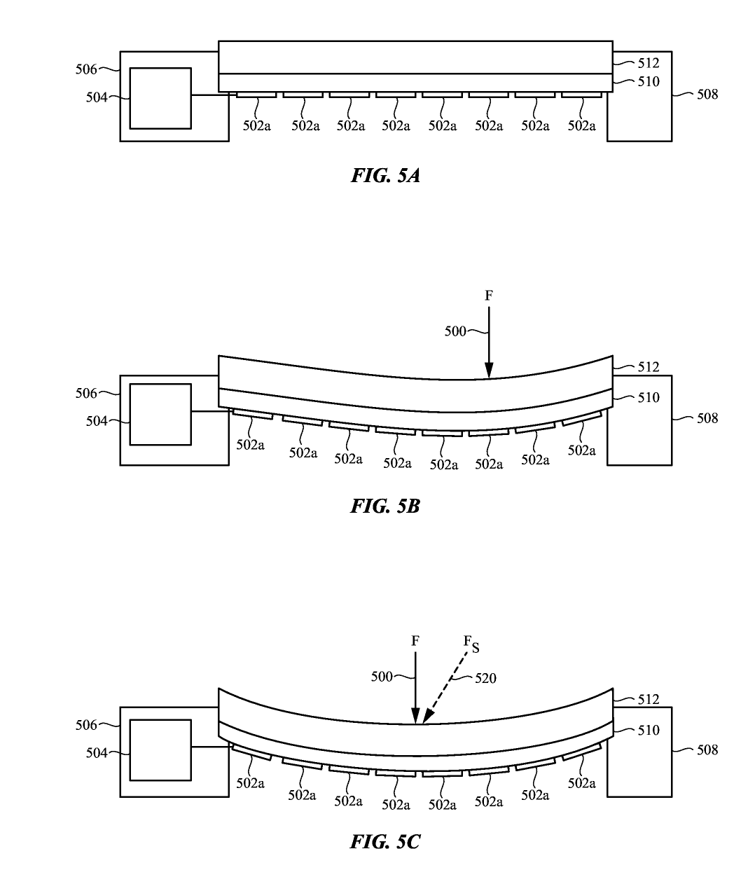

FIG. 5A depicts another example force-sensitive structure of a device. As depicted in FIG. 5A, a substrate 510 may be disposed below a force-receiving layer 502. The force-receiving layer 502 may correspond to the cover 106 depicted in FIG. 1. In some cases, the force-receiving layer 502 is configured to receive a force directly from a user. In certain cases, the force-receiving layer 502 receives a force via another layer or component of the display stack that is disposed relative to a surface of the force-receiving layer 502. In some embodiments, the force-receiving layer 502 may be made of a material having high strain transmission properties. For example, the force-receiving layer may be formed from a hard or otherwise rigid material such as glass, plastic, or metal, such that an exerted force may be effectively transmitted through the force-receiving layer 502 to the layers disposed below.

As shown in FIG. 5A, substrate 510 is disposed below the force-receiving layer 502. The substrate 510 may have a plurality of individual force-sensitive components 502 positioned thereon. In this example, the substrate 510 may be supported on both sides by support structures 506 and 508. Alternatively, the substrate 510 may be supported all around its perimeter by a support structure which anchors the substrate at an end or along a side portion while allowing a center portion of the substrate 510 to deflect in response to an applied force for force sensing. The substrate 510 may be made from an optically transparent material, such as polyethylene terephthalate (PET). The force-sensitive components 502 may be made from a piezoelectric or other strain-sensitive material, one example of which is PVDF.

In some embodiments, the force-sensitive components 502 may be connected to sense circuitry 504 that is configured to detect changes in an electrical property of each of the force-sensitive components 502. In some cases, the sense circuitry 504 may be configured to detect changes in the voltage output of the force-sensitive components 502, which can be used to estimate a force that is applied to the device. In another example, sensing circuitry 504 may be configured to measure a change in voltage output of the force-sensitive components 502, which can likewise be used to estimate an applied force. In certain embodiments, the sense circuitry 504 may also be configured to provide information about the location of the touch based on the relative difference in an electrical property of a respective force-sensitive component 502.

In some embodiments, the sensing circuitry 504 may be adapted to determine a relative measurement between the electrical response of two or more adjacent force-sensitive components 502 or a differential based on a force-sensing component that is comprised of two strain sensors, as further described below with respect to FIGS. 5B and 5C. In some cases, the electrical response of a force-sensitive component 502 may vary with the component's distance from an applied force.

As shown in FIG. 5B, force 500 may be received on the force-receiving layer 502. Due to the rigidity of the force-receiving layer 502, a force that deflects the force-receiving layer 502 may also cause the substrate 510 to at least partially deflect. Since the force-sensitive components 502 are affixed to the substrate 510, the force-sensitive components 502 may at least partially deflect as well. As a result of the force-sensitive components 502 being positioned at different distances from the location of the applied force, the force-sensitive components 502 may experience different degrees of deflection based on their location with respect to the force 500. That is, the deflection of the force-sensing components 502 may vary with the distance from the location of the force 500 of each respective force-sensitive component 502, and thus the electrical responses of those components may also vary in response to the same amount of force 500 applied. In some cases, certain force-sensing components 502 may deflect, and others may not or may deflect minimally. As an example, component 502b will experience a greater deflection than 502a since it is closer to the force 500. As another example, component 502e will experience a greater deflection than component 502a since it is closer to the force.

In some embodiments, an electrical response due to the force 500 may be measured for one or more of the components 502 and an algorithm may be used to compare a relative response of two or more adjacent components (e.g. 502a compared with 502b, 502a compared with 502e, etc.). In this manner, error present as a result of the components 502 experiencing different electrical responses due to their location relative to the location of the force 500 may be substantially reduced or eliminated. When the signals from the two components 502 are compared, the strain may appear as a differential strain. In some embodiments, the differential of the components 502 may be used to calculate a corresponding differential strain. In some cases, the differential output may be used to compute a force estimate that cancels the effects on strain due to, for example, the differences in the electrical responses of the two components 502 based on their respective distance from the force 500.

In some embodiments, the same amount of force 500 may be applied in a different location along the force-receiving layer 502, and the sense circuitry 504 may determine a force estimate based on the electrical responses of two or more adjacent components 502 that is the same as the force estimate for the force 500 applied in FIG. 5B. As shown in FIG. 5C the example force-sensitive structure of FIG. 5A has been deformed in another exemplary manner in response to an applied force 500. In some cases, the same amount of force 500 applied in FIG. 5B may be applied in a different location along the force-receiving layer 502 (e.g. more towards the center), resulting in differing responses of the force-sensitive components 502 compared to FIG. 5B. Specifically, when a force 500 is received, the force-receiving layer 502, the substrate 510, and the force-sensing components 502 may at least partially deflect, as shown in FIG. 5C. As a result of the force being applied in a different location to the force applied in FIG. 5B, the force-sensing components 502 may deflect, but to a degree that is different than the deflection by the components 502 in FIG. 5B for the same amount of force applied. For example, component 502c of FIG. 5C may experience a greater deflection than component 502c of FIG. 5B since it is closer to the force, even though the amount of force does not vary. By using a differential output of two or more adjacent components, the sense circuitry's 504 force measurement or estimate is distance invariant. Put another way, by employing a differential output of two adjacent force sensors, force measurement depends only on the distance between the two sensors. In this manner, a user applying a force on a force-receiving layer of a device may apply that force at any location and receive the same response from the force sensors of the device. Said another way, a user may receive the same output for the same input regardless of the location in which that input (e.g., force of a touch) is received. This may be particularly advantageous for a larger user input area where a uniform user experience is desired across the entire user input area.

In some cases, the applied force may be exerted at a non-right angle to the substrate. Such a force may have a normal component and a shear component 520. In such cases, the differential configuration may normalize the shear force component 520 since the shear component will produce an equal amount of axial strain in two adjacent components 502 that are axially aligned. In this manner, a force may be applied at any angle to the substrate, and the user does not need to be concerned with applying a force at an exact right angle to receive the desired output (e.g., force detection). In some embodiments, the force-sensing components may be positioned on a center axis of the substrate 510 so that the shear force component 520 may be normalized.

Additionally, the differential configuration of the force-sensitive components may lead to a temperature invariant system of the device. In some cases, the differential configuration may facilitate temperature invariance between two adjacent force-sensitive components 502. In particular, two adjacent force-sensitive components 502 may be positioned close to one another such that a temperature variance does not exist between the components 502. In this manner, since there is no temperature variance between components, the entire system may be temperature invariant.

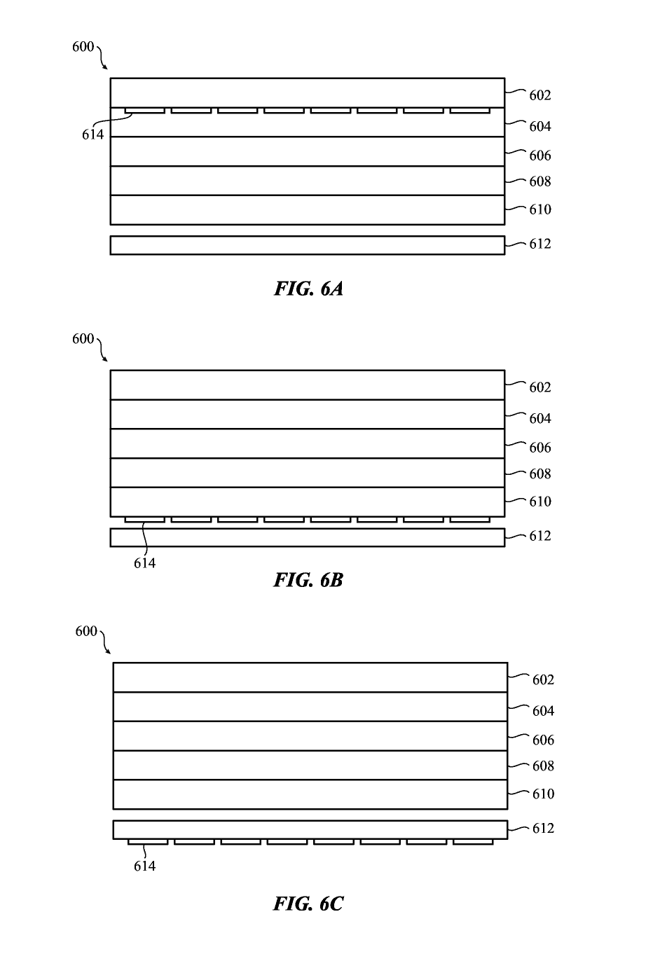

FIGS. 6A-C illustrate an example structures for a display stack having a force-sensitive structure integrated therein. As depicted, a display stack 600 may include a display, such as an LCD display, LED display, OLED display, or the like, and the layers that constitute the display. For example, a top layer in the display stack 600 may be a cover 602, such as a cover glass. The cover 602 may be coupled to a front polarizer 606, a display 608, and a rear polarizer 610 with some adhesive 604. The adhesive 604 may be an optically clear adhesive. The display stack 600 may also include a support structure 612 for providing support and structure to the stackup when incorporated in a device.

FIG. 6A illustrates an example display stack of a device having a force-sensitive structure disposed beneath a cover layer of the display stack. In some embodiments, a force-sensitive structure comprising force-sensitive components 614 may be disposed on a bottom surface of the cover 602. In other embodiments, the force-sensitive components 614 may be located in different positions within the display stack 600. The positioning may depend upon the type of display into which the force-sensitive components are placed. Additionally, or alternatively, the location of the force-sensing components within the display stack may depend upon the optical characteristics of the force-sensing components. For example, if the force-sensing components may have a negative impact on the image of the display, then it may be preferable to position the force-sensitive components behind the rear polarizer 610 and display 608.

FIG. 6B illustrates an example embodiment in which the force-sensitive components 614 are disposed beneath the rear polarizer 610 of the display stack 600. FIG. 6C illustrates yet another example embodiment in which the force-sensitive components are disposed beneath the support structure 612 of the display stack 600. Alternative placement of the force-sensitive components 614 may be contemplated. For example, the force-sensitive components 614 may be disposed beneath the display 608, above the support structure 612, or positioned within or on another layer of the display stack 600. In some embodiments, the force-sensitive components 614 may deflect with the layers of the display stack 600 as it is subjected to force. In some cases, the force-sensitive components 614 may deflect more sharply when disposed under the cover 602 relative to being disposed under the rear polarizer 610 or other layer in the display stack 600.

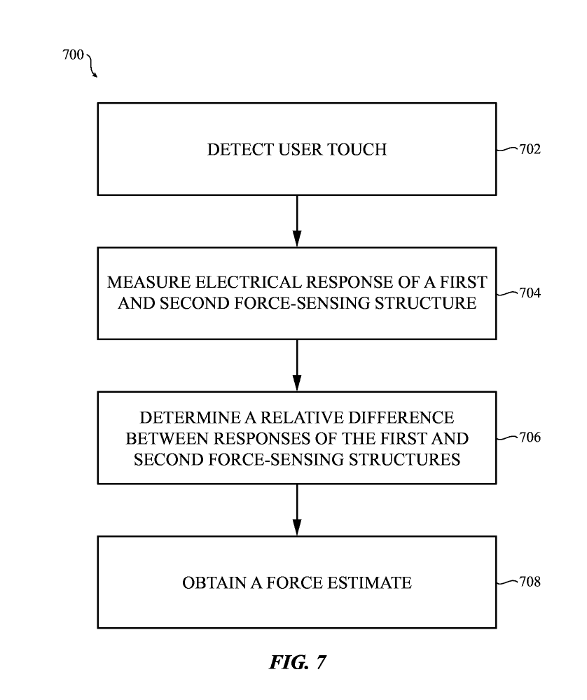

FIG. 7 is a flow chart illustrating one example method for obtaining a force estimate which compensates for a variation in response based on a location of force-sensitive structures relative to a location of the applied force. Method 700 may be used, for example, to operate one or more of the force sensors described with respect to FIGS. 3-6, above.

In operation 702, an occurrence of a user touch may be detected. The touch may be detected, for example using a touch sensor. The touch sensor may include, for example, a self-capacitive, mutually capacitive, resistive, or other type of touch sensor. In some embodiments, the occurrence of a touch may be detected by the force sensor. For example, a change in strain or resistance of one or more force-sensitive structures of the sensor may be used to detect the occurrence of a touch. In some embodiments, operation 702 is not necessary. For example, the other operations of process 700 may be performed on a regularly repeating or irregular interval without first determining if a touch is present. For example, process 700 may be performed and calculate or estimate a zero applied force, which may be due to the absence or lack of a touch on the device.

In operation 704, an electrical measurement of two or more individual force-sensitive components is obtained. The electrical measurement may be a measure of a change in an electrical response of the force-sensitive components, and it may be measured using sense circuitry configured to detect a change in an electrical property of the force-sensitive components. For example, the sense circuitry may be configured to measure a change in the voltage output of each force-sensitive component. In some cases, the sense circuitry may be configured to measure a charge or voltage generated by the force-sensitive components.

In operation 706, a relative measurement between the two or more force-sensitive components may be obtained. In some embodiments, a differential configuration may compare measurements between two or more force-sensitive components to obtain a relative difference between the two or more force-sensitive components. In operation 708, a force estimate may be computed based on the relative difference. In some embodiments, the force estimate compensates for variations in the responses of the two or more force-sensitive components based on their location relative to the location of the force being applied.

The foregoing description, for purposes of explanation, used specific nomenclature to provide a thorough understanding of the described embodiments. However, it will be apparent to one skilled in the art that the specific details are not required in order to practice the described embodiments. For example, the electronic device 100 described herein may be a mobile phone, a tablet computing device, a computer display, a notebook computing device, a desktop computing device, a computing input device (such as a touch pad, track pad, keyboard, or mouse), a wearable device, a health monitor device, a sports accessory device, and so on.

Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A force sensor for detecting force on a surface of a device, comprising:
a force-receiving layer;
a substrate disposed below the force-receiving layer;
a first force-sensitive component disposed on a surface of the substrate;
a second force-sensitive component disposed proximate to the first force-sensitive component;
sensor circuitry operatively coupled to the first and second force-sensitive components, configured to compare a relative electrical response between the first force-sensitive component and the second force-sensitive component to compute a force estimate, wherein:
the force estimate compensates for a variation in response based on the location of the components relative to a location of the force.

2. The force sensor of claim 1, wherein the substrate is configured to deflect in response to a force of a touch on the force-receiving layer.

3. The force sensor of claim 2, wherein the first force-sensitive component experiences a first amount of tension and the second force-sensitive component experiences a second amount of tension in response to the force of the touch, the first and second amounts of tension varying based on the location of the force.

4. The force sensor of claim 1, wherein the first and second force-sensitive components are made of a piezoelectric material.

5. The force sensor of claim 1, wherein the first force-sensitive component has a geometry which is distinct from the second force-sensitive component.

6. The force sensor of claim 1, wherein the first force-sensitive component is disposed on a first side of the substrate, and the second force-sensitive component is disposed on a second side of the substrate that is opposite to the first side.

7. An electronic device having a force sensor, comprising:
a display;
a cover disposed above the display and forming a portion of an outer surface of the device;
a first force-sensing component disposed below the cover and formed from a strain-sensitive material;
a second force-sensing component disposed adjacent the first force-sensing component and formed from a strain-sensitive material;
a sensor circuit operatively coupled to the first and second force-sensing components, configured to measure a relative difference between an electrical response of the first and second force-sensing components in response to a force of a touch on the cover, and compute a force estimate using the relative difference.

8. The electronic device of claim 7, wherein the first and second force-sensing components are disposed on an underside of the cover.

9. The electronic device of claim 7, further comprising a polarizer disposed below the display, and wherein:
the first and second force-sensing components are disposed on a surface of the polarizer.

10. The electronic device of claim 7, further comprising a transparent substrate disposed below the cover, and wherein:
the first and second force-sensing components are disposed on a surface of the substrate.

11. The electronic device of claim 10, wherein the first force-sensing component is disposed on a first surface of the substrate, and the second force-sensing component is disposed on a second surface of the substrate that is opposite to the first surface.

12. The electronic device of claim 7, wherein the first and second force-sensing components are disposed relative to the display.

13. The electronic device of claim 7, further comprising one or more layers forming a display stack of the electronic device, wherein:
the first and second force-sensing components are disposed relative to the one or more layers of the display stack.

14. The electronic device of claim 13, wherein the first and second force-sensing components are configured to deform with the display stack in response to the force of the touch.

15. The electronic device of claim 14, wherein the deformation of the first and second force-sensing components generates an electrical response from the first and second force-sensing components, the electrical response corresponding to an amount of deformation of each force-sensing component.

16. The electronic device of claim 15, wherein:
the electrical response of the first force-sensing component differs from the electrical response of the second force-sensing component; and
the force estimate compensates for the difference in the responses.

17. A method for estimating a force applied to a surface of a device, including:
detecting a touch on the surface;
measuring an electrical response of a first force-sensitive structure positioned relative to the surface and a second force-sensitive structure positioned proximate to the first force-sensitive structure in response to a force of the touch;
determining a relative difference between the electrical response of the first force-sensitive structure and the electrical response of the second force-sensitive structure; and
computing a force estimate based on the relative difference.

18. The method of claim 17, further comprising:
compensating for temperature effects on the force estimate using the relative difference.

19. The method of claim 17, wherein the first and second force-sensitive structures are formed from piezoelectric material.

20. The method of claim 17, wherein the first and second force-sensitive structures are configured to detect the touch on the surface.
